(19) United States
(12) Patent Application Publication
(10) Pub. No.: US 2009/0252217 A1
(43) Pub. Date: Oct. 8, 2009

(54) SYSTEM AND METHOD FOR LAYERED DIGITAL VIDEO CODING IN A DIGITAL VIDEO RECORDER

(76) Inventor: Karl R. Wittig, New York, NY (US)

Correspondence Address: PHILIPS INTELLECTUAL PROPERTY & STANDARDS, P.O. BOX 3001, BRIARCLIFF MANOR, NY, 10510, US

(21) Appl. No.: 11/721,242

(22) PCT Filed: Dec. 8, 2005
(86) PCT No.: PCT/IB2005/054132

§ 371 Date: Jun. 8, 2007

Related U.S. Application Data
(60) Provisional application No. 60/635,201, filed on Dec. 10, 2004.

(51) Int. Cl. H04N 7/26

(52) U.S. Cl. 375/240.01; 375/E07.198

(57) ABSTRACT

A video server (102), video client (104), methods (600, 700), and computer programs are provided for partitioning and presenting video content. A partitioning method (600) and a video server (102) partition video content into multiple layers before storage of the video content. At least some of the multiple layers of the video content are then retrieved and provided for presentation. A presenting method (700) and video client (104) receive and combine at least some of the multiple layers of the video content into a video data stream. The video data stream is decoded, and a video signal is provided for presentation on a display device.

This disclosure relates generally to video coding systems and more specifically to a system and method for layered digital video coding in a digital video recorder.

Digital video recorders (“DVRs”) are becoming more and more popular in the United States and around the world. Digital video recorders, also known as personal video recorders (“PVRs”) and personal television recorders (“PTRs”), record television programs; movies, and other content on digital storage media such as hard disk drives. The recorded content may then be retrieved from the storage media and presented to users of the digital video recorders.

Conventional digital video recorders often allow users in remote locations to retrieve content stored on the digital video recorders. For example, users could watch a movie on a television located in one room, where the movie is stored on a digital video recorder located in another room. The content from the digital video recorder is typically communicated over a network. A problem with conventional digital video recorders is that networks used to transport content from the digital video recorders are often susceptible to reductions in bandwidth, such as reductions caused by congestion and/or interference. These reductions in bandwidth often result in unacceptable degradation of the content communicated over the networks and presented to users.

This disclosure provides a system and method for layered digital video coding in a digital video recorder.

In one aspect, an apparatus includes at least one of one or more encoders and one or more transcoders capable of partitioning video content into multiple layers. The apparatus also includes a storage device capable of storing the multiple layers of the partitioned video content. In addition, the apparatus includes a data reader capable of retrieving at least some of the multiple layers of the partitioned video content from the storage device and providing at least some of the multiple layers of the partitioned video content for presentation of the video content on a display device.

In another aspect, an apparatus includes a layer combiner capable of receiving at least some of multiple layers of partitioned video content from a video server and combining the received layers of the partitioned video content into a video data stream. The video server is capable of partitioning the video content into the multiple layers before storage of the multiple layers. The apparatus also includes a digital video decoder capable of decoding the video data stream and providing a video signal for presentation.

For a more complete understanding of the this disclosure, reference is now made to the following description, taken in conjunction with the accompanying drawings, in which:

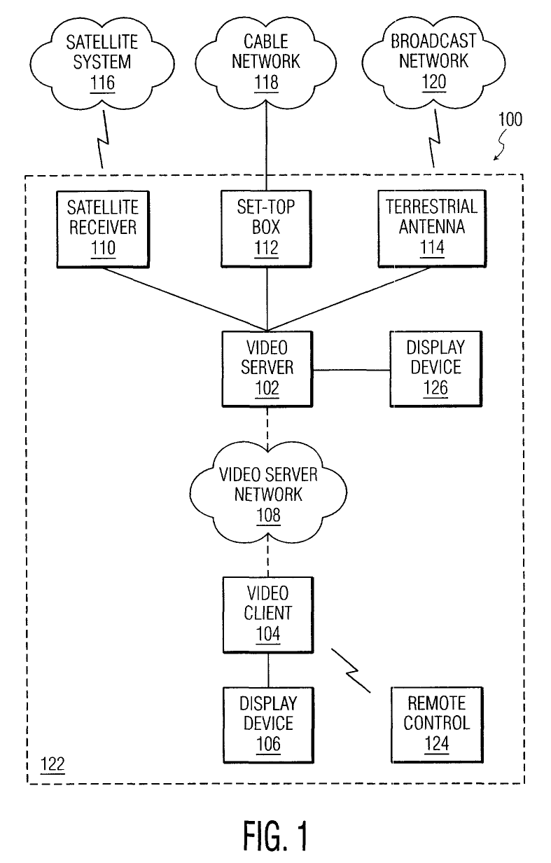

FIG. 1 illustrates an example multi-layer streaming digital video system according to one embodiment of this disclosure;

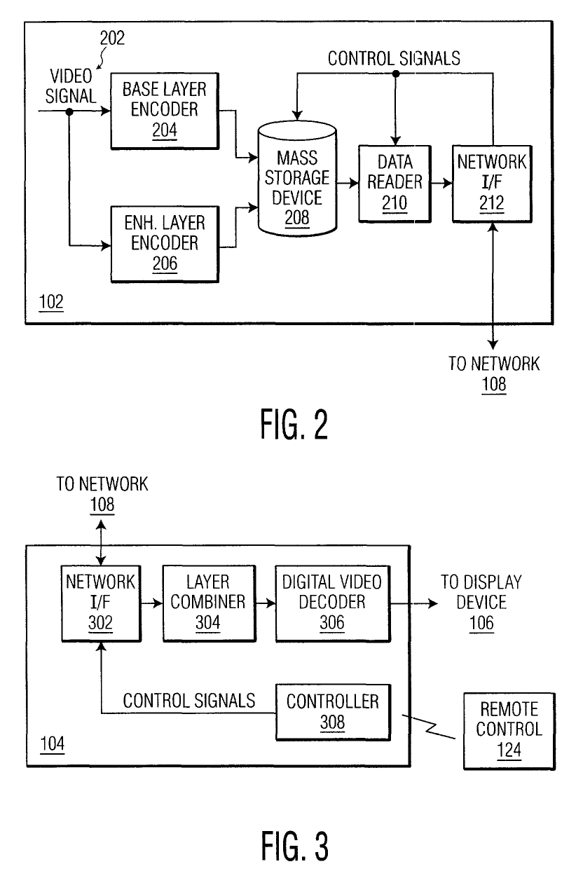

FIG. 2 illustrates an example video server according to one embodiment of this disclosure;

FIG. 3 illustrates an example video client according to one embodiment of this disclosure;

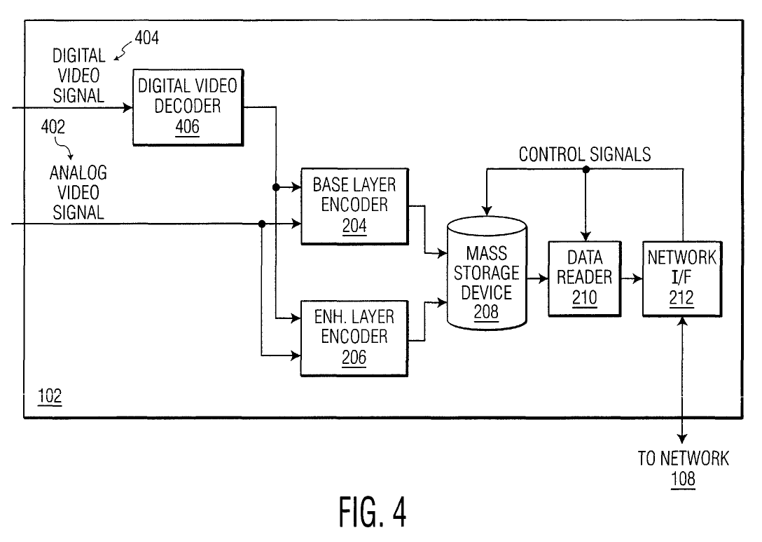

FIG. 4 illustrates another example video server according to one embodiment of this disclosure;

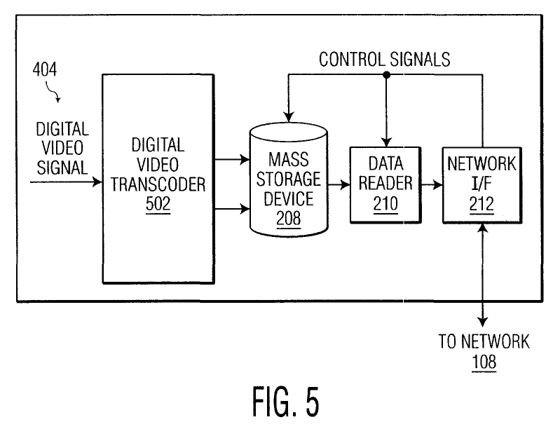

FIG. 5 illustrates yet another example video server according to one embodiment of this disclosure;

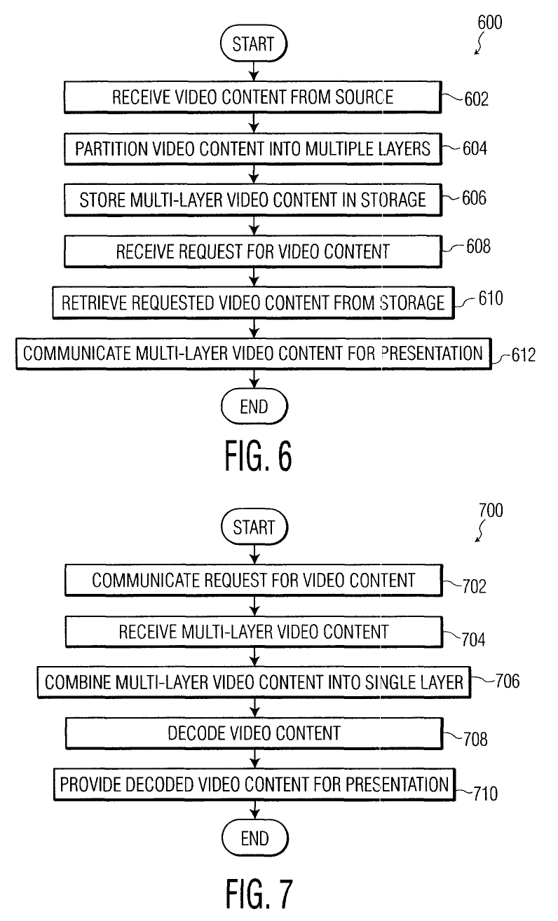

FIG. 6 illustrates an example method for providing multi-layer streaming digital video according to one embodiment of this disclosure; and

FIG. 7 illustrates an example method for presenting multi-layer streaming digital video according to one embodiment of this disclosure.

FIGS. 1 through 7, discussed below, and the various embodiments described in this patent document are by way of illustration only and should not be construed in any way to limit the scope of the invention. Those skilled in the art will understand that the principles of the invention may be implemented in any suitably arranged apparatus, device, or structure.

FIG. 1 illustrates an example multi-layer streaming digital video system 100 according to one embodiment of this disclosure. In the illustrated example, the system 100 includes a streaming digital video server 102, a streaming digital video client 104, a display device 106, and a network 108. The embodiment of the digital video system 100 shown in FIG. 1 is for illustration only. Other embodiments of the digital video system 100 may be used without departing from the scope of this disclosure.

The video server 102 is coupled to the network 108. In this document, the term “couple” and its derivatives refer to any direct or indirect communication between two or more elements, whether or not those elements are in physical contact with one another. The video server 102 streams video content to the video client 104 over the network 108. For example, the video server 102 could provide television programs, movies, commercials, and pay-per-view programs to the video client 104. Although the description below often refers to the video server 102 providing video content to the video client 104, the video server 102 could also provide any additional content to the video client 104, such as audio content or non-video graphics. The video server 102 includes any hardware, software, firmware, or combination thereof for providing video content to the video client 104. Example embodiments of the video server 102 are shown in FIGS. 2, 4, and 5, which are described below.

The video server 102 could receive video content or other content from any source or sources. In this example embodiment, the video server 102 receives content from a satellite television receiver 110, a cable set-top box 112, and a terrestrial antenna 114. The satellite television receiver 110 receives content from a satellite television system 116. The cable set-top box 112 receives content from a cable television network 118, which may represent an analog and/or digital network. The terrestrial antenna 114 receives content from a broadcast network 120. This represents three possible sources of content received by the video server 102. The video server 102 could receive content from a subset of these sources. The video server 102 could also receive content from any other or additional content sources, such as from or through a high definition television (“HDTV”) receiver, a personal computer, a videocassette recorder (“VCR”), a digital versatile disk (“DVD”) player, a radio receiver, or any other source(s).

The video client 104 is coupled to the network 108. The video client 104 receives the video content streamed over the network 108 by the video server 102. The video client 104 then processes the received video content for presentation to one or more users. For example, the video client 104 could process the video content for presentation on a display device 106. Although the description below often refers to the video client 104 receiving video content from the video server 102, the video client 104 could also receive, process, and present any additional content, such as audio content or non-video graphics. The video client 104 includes any hardware, software, firmware, or combination thereof for receiving video content from the video server 102. An example embodiment of the video client 104 is shown in FIG. 3, which is described below.

The display device 106 is coupled to the video client 104. The display device 106 is capable of presenting video content received by the video client 104 to one or more users. The display device 106 may also be capable of presenting other content, such as audio content, to the users. The display device 106 includes any structure capable of presenting video content to users, such as a television or a computer display.

The network 108 couples the video server 102 and the video client 104. The network 108 facilitates the communication of information, such as video content and control signals, between the video server 102 and the video client 104. For example, the network 108 may communicate Internet Protocol (IP) packets or other suitably formatted information between network addresses. The network 108 may also operate according to any appropriate type of protocol or protocols, such as Ethernet protocols. The network 108 represents any wireline network, wireless network, or combination of networks capable of transporting information, such as a wireless Ethernet network.

As a particular example of the system 100, the various components 102-114 shown in FIG. 1 may reside in a home or other residence 122. The video server 102 may be located in one room of the residence 122, and the video client 104 may be located in another room of the residence 122. The network 108 could represent a wireless network that allows video content from the video server 102 to be provided to the video client 104.

As shown in FIG. 1, a user may operate a remote control 124 to control the operation of the local video client 104 and the remote video server 102. For example, the user may use the remote control 124 to select the video content to be retrieved from the video server 102. Signals received by the video client 104 from the remote control 124 could be provided to the video server 102 over the network 108 or in any other manner.

In one aspect of operation, video content is transmitted over the network 108. As the video content is transmitted over the network 108, the network 108 may suffer from changes in bandwidth, such as bandwidth lost due to interference and/or congestion. This degradation could lead to an unacceptable degradation of the video content received by the video client 104 and presented to users.

To help compensate for the potential degradation of the network 108, the video server 102 uses a layered encoding scheme to encode the video content transmitted over the network 108. For example, the video content may be partitioned into essential or “base” information in a “base layer” and less essential or “enhancement” information in one or more “enhancement layers.” The base information represents information needed for the video client 104 to generate and display intact and viewable images. The enhancement information represents information used by the video client 104 to improve the quality of the intact and viewable images. In this document, the term “partition” and its derivatives refer to any production of multiple layers of information, whether the production involves a simple separation of information or the generation of information through encoding or other mechanisms.

The video server 102 attempts to communicate all of the base information over the network 108. If the bandwidth of the network 108 allows it, the video server 102 also attempts to communicate at least some of the enhancement information over the network 108. In this way, the video client 104 should receive at least the minimum amount of information needed to generate intact video images for presentation.

In some embodiments, the partitioning of video content into base information and enhancement information occurs in real-time and before the video content is stored by the video server 102. In these embodiments, the video content is partitioned before storage, rather than the video server 102 storing the content and later partitioning the content into base information and enhancement information after the video content is requested by a user. Because the video content is partitioned before storage, the video content may be provided and displayed to the user with less latency or delay.

This technique for partitioning video content before storage may provide additional benefits in the system 100. For example, the video server 102 often provides various control functions (such as play, stop, pause, fast forward, and rewind) that are used to control the presentation of video content. A user may use the remote control 124 to invoke the control functions supported by the video server 102. In response to the user selecting a control function, the remote control 124 communicates a control command to the video client 104. The video client 104 forwards the command to the video server 102, such as by communicating the command over the network 108. If the command involves presenting content to the user, the video server 102 retrieves and communicates the content to the video client 104, the video client 104 decodes the content, and the display device 106 presents the content to the user.

The user typically expects to see a response to a control command within an acceptable amount of time. For example, the user often expects video content to be presented to the user within a reasonable amount of time after depressing a “play” button on the remote control 124. The partitioning of video content into base information and enhancement information before storage helps to ensure that video content is provided to the video client 104 for presentation within an acceptable amount of time. In particular, when content is requested, the video server 102 may retrieve and provide the layer(s) of information to the video client 104. The video server 102 does not need to partition the video content into base information and enhancement information after the video content is requested, so the video content may be received by the video client 104 more quickly. This may enable the display device 106 to receive and present the video content in a more timely manner.

Although FIG. 1 illustrates one example of a multi-layer streaming digital video system 100, various changes may be made to FIG. 1. For example, the system 100 may include any number of video servers 102, video clients 104, display devices 106, networks 108, content sources 110-114, and remote controls 124. Also, various components shown in FIG. 1 may be integrated in a single physical unit. As particular examples, the video client 104 and the display device 106 may be integrated into a single physical unit. Similarly, the video server 102 could be integrated into the satellite television receiver 110 or the cable set-top box 112. In addition, a display device 126 could be coupled to the video server 102, and the video server 102 could be capable of both providing video content to the video client 104 and displaying video content on the display device 126.

FIG. 2 illustrates an example video server 102 according to one embodiment of this disclosure. The embodiment of the video server 102 shown in FIG. 2 is for illustration only. Other embodiments of the video server 102 may be used without departing from the scope of this disclosure. Also, for ease of explanation, the video server 102 shown in FIG. 2 is described as operating in the system 100 of FIG. 1. The video server 102 of FIG. 2 could be used in any other system.

As shown in FIG. 2, the video server 102 receives a video signal 202. The video signal 202 represents any signal containing video information to be presented on a display device 106. In this example, the video signal 202 represents an uncoded signal, or a signal that has not been encoded. The video signal 202 could, for example, represent analog television signals from an analog cable set-top box 112 or from a terrestrial antenna 114.

The video signal 202 is provided to a base layer encoder 204 and an enhancement layer encoder 206. The base layer encoder 204 and the enhancement layer encoder 206 encode the video signal 202 into multiple layers, including a base layer and one or more enhancement layers. For example, the encoders 204-206 may perform motion-compensated predictive coding for the base layer and discrete cosine transform (“DCT”) residual coding for the enhancement layer(s). As a particular example, the base layer encoder 204 may implement Motion Pictures Expert Group (“MPEG”) encoding, and the enhancement layer encoder 206 may implement Fine Granularity Scalability (“FGS”) or Rate-Distortion Data Partitioning (“RDDP”) or other data partitioning encoding. Each of the encoders 204-206 represents any hardware, software, firmware, or combination thereof for encoding base layer or enhancement layer information.

A mass storage device 208 is coupled to the encoders 204-206. The mass storage device 208 receives and stores encoded video content from the encoders 204-206. For example, the mass storage device 208 may store an encoded base layer and one or more encoded enhancement layers for particular video content. The mass storage device 208 also allows the stored video content to be retrieved for presentation. The mass storage device 208 represents any storage device or devices, such as a hard disk drive. Also, the mass storage device 208 could be fixed or portable (removable).

A data reader 210 is coupled to the mass storage device 208. The data reader 210 retrieves requested video content from the mass storage device 208 and provides the retrieved content for presentation. For example, the data reader 210 could retrieve and stream a stored television program from the mass storage device 208 to the video client 104 over the network 108. In particular, the data reader 210 may retrieve the encoded base layer and enhancement layer(s) associated with requested content and provide the layers for communication over the network 108. The data reader 210 includes any hardware, software, firmware, or combination thereof for retrieving and streaming video content. In some embodiments, the data reader 210 retrieves all layers of requested content and attempts to provide as many layers as possible to the video client 104. In other embodiments, the data reader 210 identifies the bandwidth of the network 108 and retrieves only some of the layers of requested content based on the identified bandwidth.

A network interface 212 is coupled to the data reader 210. The network interface 212 allows the video server 102 to communicate over the network 108. For example, the network interface 212 may allow the video server 102 to transmit video content over the network 108 and receive control commands over the network 108. The network interface 212 includes any hardware, software, firmware, or combination thereof for facilitating communication over a network. The network interface 212 could, for example, represent an interface to a wireless Ethernet network.

As shown in FIG. 2, the video signal 202 is partitioned into the base layer and one or more enhancement layers before storage in the mass storage device 208. This may help to facilitate faster presentation of video content to users in the system 100. Conventional digital video recorders would store the video signal 202 in the mass storage device 208 as a single layer stream. The video server 102 shown in FIG. 2 encodes the video signal 202 as multiple layers before storage in the mass storage device 208. As a result, the video content may be provided directly to the video client 104 for presentation without requiring additional encoding. Moreover, the processing requirements and latency associated with encoding the video signal 202 as base and enhancement layers are typically low when compared to the processing requirements and latency associated with encoding content as a single-layer stream.

To present the video content, the data reader 210 retrieves the base layer and one or more enhancement layers from the mass storage device 208. The base information in the base layer is then transmitted over the network 108 through the network interface 212. Also, none, some, or all of the enhancement information in the enhancement layer(s) may be transmitted over the network 108. The amount of enhancement information transmitted may depend, for example, on the current bandwidth of the network 108.

As shown in FIG. 2, the mass storage device 208 and the data reader 210 may receive control signals from the video client 104 over the network 108. The control signals could, for example, represent messages corresponding to buttons on a remote control 124 depressed by a user. The mass storage device 208 and the data reader 210 may use the control signals in any manner. For example, the mass storage device 208 could use the signals to delete a program that the user does not wish to keep. As another example, the data reader 210 could temporarily stop retrieving and streaming video content over the network 108 when the user invokes a pause function.

Although FIG. 2 illustrates one example of a video server 102, various changes may be made to FIG. 2. For example, the functional division in FIG. 2 is for illustration only. Various components in FIG. 2 could be combined or omitted and additional components could be added according to particular needs. As a specific example, the encoders 204-206 could be combined into a single functional unit.

FIG. 3 illustrates an example video client 104 according to one embodiment of this disclosure. The embodiment of the video client 104 shown in FIG. 3 is for illustration only. Other embodiments of the video client 104 may be used without departing from the scope of this disclosure. Also, for ease of explanation, the video client 104 shown in FIG. 3 is described as operating in the system 100 of FIG. 1. The video client 104 of FIG. 3 could be used in any other system.

As shown in FIG. 3, the video client 104 receives layered video content over the network 108 through a network interface 302. The network interface 302 allows the video client 104 to communicate over the network 108, such as by receiving video content and transmitting control commands. As a particular example, the network interface 302 allows the video client 104 to receive a base layer and possibly one or more enhancement layers associated with requested video content from the video server 102 over the network 108. The network interface 302 includes any hardware, software, firmware, or combination thereof for facilitating communication over a network, such as an interface to a wireless Ethernet network.

A layer combiner 304 is coupled to the network interface 302. The video content received by the network interface 302 over the network 108 includes partitioned base and enhancement layers. The layer combiner 304 combines the information from the base and enhancement layers into a single video stream. As particular examples, the layer combiner 304 could implement FGS or RDDP to combine the base and enhancement layers. The layer combiner 304 includes any hardware, software, firmware, or combination thereof for combining layered video information.

A digital video decoder 306 is coupled to the layer combiner 304. The digital video decoder 306 decodes the encoded video information provided by the layer combiner 304. The digital video decoder 306 also presents the decoded video content for presentation by the display device 106. For example, the digital video decoder 306 could convert the encoded video information into an analog or digital video signal for presentation by the display device 106. The digital video decoder 306 includes any hardware, software, firmware, or combination thereof for decoding video content, such as an MPEG decoder.

In this example, a controller 308 is coupled to the network interface 302. The controller 308 receives signals from the remote control 124, where the signals identify various functions that a user of the remote control 124 wishes to invoke. For example, the signals could indicate that the user has depressed a play, stop, pause, fast forward, or rewind button on the remote control 124. The controller 308 receives the signals from the remote control 124 and communicates control signals to the video server 102 over the network 108. The control signals could, for example, cause the video server 102 to begin playing selected video content, to pause playback of selected content, or to stop playback. The controller 308 could also perform functions in response to the commands from the remote control 124, such as by displaying menus for the user to navigate or powering off the video client 104. The menus could represent any menus, such as menus listing the video content available for playback. The controller 308 includes any hardware, software, firmware, or combination thereof for generating control signals based on input from a remote control.

As described above, the video server 102 partitions video content into a base layer and one or more enhancement layers before storage. When a user indicates that selected video content is desired using the remote control 124 or another mechanism, the controller 308 signals the video server 102. The video server 102 then retrieves the desired content and provides the content to the video client 104. The video server 102 does not need to encode the retrieved content into layers before transmission. As a result, the video client 104 may receive the requested video content more quickly, which may allow the content to be provided to the user more quickly.

Although FIG. 3 illustrates one example of a video client 104, various changes may be made to FIG. 3. For example, the functional division in FIG. 3 is for illustration only. Various components in FIG. 3 could be combined or omitted and additional components could be added according to particular needs.

FIG. 4 illustrates another example video server 102 according to one embodiment of this disclosure. The embodiment of the video server 102 shown in FIG. 4 is for illustration only. Other embodiments of the video server 102 may be used without departing from the scope of this disclosure. Also, for ease of explanation, the video server 102 shown in FIG. 4 is described as operating in the system 100 of FIG. 1. The video server 102 of FIG. 4 could be used in any other system.

This embodiment of the video server 102 receives both analog video signals 402 and digital video signals 404. As particular examples, the analog video signals 402 may represent analog television signals from an analog cable set-top box 112 or from a terrestrial antenna 114. Also, the digital video signals 404 may represent digital television signals from a satellite television receiver 110 or from a digital cable set-top box 112.

In the illustrated example, the video server 102 includes the various components 204-212 shown in FIG. 2 and described above. The analog video signals 402 are processed by the video server 102 in the manner described above with respect to FIG. 2. The digital video signals 404 are provided to a digital video decoder 406. The digital video decoder 406 decodes the digital video signals 404 and generates corresponding analog video signals. The analog video signals produced by the digital video decoder 406 are then provided to the encoders 204-206 for encoding as described above. The digital video decoder 406 includes any hardware, software, firmware, or combination thereof for decoding digital signals. The digital video decoder 406 could, for example, implement MPEG decoding.

Although FIG. 4 illustrates another example of a video server 102, various changes may be made to FIG. 4. For example, the functional division in FIG. 4 is for illustration only. Various components in FIG. 4 could be combined or omitted and additional components could be added according to particular needs.

FIG. 5 illustrates yet another example video server 102 according to one embodiment of this disclosure. The embodiment of the video server 102 shown in FIG. 5 is for illustration only. Other embodiments of the video server 102 may be used without departing from the scope of this disclosure. Also, for ease of explanation, the video server 102 shown in FIG. 5 is described as operating in the system 100 of FIG. 1. The video server 102 of FIG. 5 could be used in any other system.

As shown in FIG. 5, the video server 102 includes the various components 208-212 shown in FIG. 2 and described above. This embodiment of the video server 102 receives only the digital video signals 404. Rather than converting the digital video signals 404 into analog signals for processing by the encoders 204-206 as shown in FIG. 4, the video server 102 shown in FIG. 5 provides the digital video signals 404 to a digital video transcoder 502. The digital video transcoder 502 decodes the digital video signals 404 and then re-encodes the content from the digital video signals 404 into multiple layers. For example, the digital video transcoder 502 may perform MPEG decoding to decode the digital video signals 404 and then perform FGS or RDDP to encode the video content from the digital video signals 404 into multiple layers. The digital video transcoder 502 provides the encoded multi-layer content to the mass storage device 208 for storage. The digital video transcoder 502 includes any hardware, software, firmware, or combination thereof for transcoding digital content.

Although FIG. 5 illustrates yet another example of a video server 102, various changes may be made to FIG. 5. For example, the functional division in FIG. 5 is for illustration only. Various components in FIG. 5 could be combined or omitted and additional components could be added according to particular needs.

While FIGS. 2-5 have illustrated various examples of the video server 102 and an example of the video client 104, the various embodiments shown in FIGS. 2-5 could be combined. For example, a video server 102 could include the encoders 204-206, the digital video decoder 406, and the digital video transcoder 502. Also, the video server 102 could include the various components from the video client 104. The data reader 210 could then retrieve stored video content and provide the video content to the layer combiner 304 and digital video decoder 306 for processing and presentation. This allows the video server 102 to act as a video client and provide video signals for presentation on a display device 126 coupled to the video server 102.

FIG. 6 illustrates an example method 600 for providing multi-layer streaming digital video according to one embodiment of this disclosure. For ease of explanation, the method 600 is described with respect to the video server 102 operating in the system 100 of FIG. 1. The method 600 could be used by any other device and in any other system.

The video server 102 receives video content from at least one source at step 602. This may include, for example, the video server 102 receiving analog video signals 202, 402 from an analog cable set-top box 112 or terrestrial antenna 114. This may also include the video server 102 receiving digital video signals 404 from a digital cable set-top box 112 or satellite television receiver 110.

The video server 102 partitions the received video content into multiple layers at step 604. This may include, for example, the encoders 204-206 encoding the analog video signals 202, 402 as a base layer and one or more enhancement layers. This may also include the digital video decoder 406 decoding the digital video signals 404 and the encoders 204-206 encoding the analog signals produced by the digital video decoder 406. This may further include the digital video transcoder 502 transcoding the digital video signals 404 into the base and enhancement layers.

The video server 102 stores the multi-layer video content at step 606. This may include, for example, the video server 102 storing the base and enhancement layers in the mass storage device 208.

The video server 102 receives a request for video content at step 608. This may include, for example, the video server 102 receiving a control signal requesting particular video content from the video client 104 over the network 108. This may also include the network interface 212 providing the control signal to the mass storage device 208 and/or data reader 210.

The video server 102 retrieves the requested video content from storage at step 610. This may include, for example, the data reader 210 retrieving the base and enhancement layers corresponding to the requested video content from the mass storage device 208.

The video server 102 communicates the multi-layer video content for presentation at step 612. This may include, for example, the data reader 210 providing the retrieved base and enhancement layers to the network interface 212 for communication over the network 108.

Although FIG. 6 illustrates one example of a method 600 for providing multi-layer streaming digital video, various changes may be made to FIG. 6. For example, the video server 102 could be coupled to a display device 126, and step 612 could involve communicating the retrieved content to a local decoder for decoding and presentation. Also, the video server 102 need not communicate the enhancement layer(s) over the network 108 at step 612 if the bandwidth of the network 108 prevents it at this particular point in time.

FIG. 7 illustrates an example method 700 for presenting multi-layer streaming digital video according to one embodiment of this disclosure. For ease of explanation, the method 700 is described with respect to the video client 104 operating in the system 100 of FIG. 1. The method 700 could be used by any other device and in any other system.

The video client 104 communicates a request for video content at step 702. This may include, for example, the controller 308 providing a list of available content to the user and the user using a remote control 124 to select content from the list. This may also include the controller 308 generating control signals identifying the desired content and communicating the control signals to the video server 102 over the network 108 through the network interface 302.

The video client 104 receives multi-layer video content at step 704. This may include, for example, the network interface 302 receiving base and enhancement layers corresponding to the requested video content from the video server 102 over the network 108.

The video client 104 combines the multi-layer content into a single layer at step 706. This may include, for example, the layer combiner 304 combining the base and enhancement layers into a single video data stream.

The video client 104 decodes the video content at step 708. This may include, for example, the digital video decoder 306 decoding the video data stream provided by the layer combiner 304.

The video client 104 provides the decoded video content for presentation at step 710. This may include, for example, the video client 104 communicating the decoded video signals to a display device 106, such as a television. If the video client 104 is integrated into the display device 106, this may include the video client 104 providing the decoded video signals to the internal circuitry of the display device 106.

Although FIG. 7 illustrates one example of a method 700 for presenting multi-layer streaming digital video, various changes may be made to FIG. 7. For example, the video client 104 may not receive the enhancement layer(s) over the network 108 at step 704 if the bandwidth of the network 108 prevents it at this particular point in time.

It may be advantageous to set forth definitions of certain words and phrases that have been used in this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, firmware, or software, or a combination of at least two of the same. It should be noted that the functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

1. An apparatus (102), comprising:
at least one of one or more encoders (204, 206) and one or more transcoders (502) capable of partitioning video content into multiple layers;
a storage device (208) capable of storing the multiple layers of the partitioned video content; and
a data reader (210) capable of retrieving at least some of the multiple layers of the partitioned video content from the storage device (208) and providing at least some of the multiple layers of the partitioned video content for presentation of the video content on a display device.

2. The apparatus (102) of claim 1, wherein the at least one of the one or more encoders (204, 206) and the one or more transcoders (502) comprises:
a base layer encoder (204) capable of generating a base layer; and
an enhancement layer encoder (206) capable of generating at least one enhancement layer.

3. The apparatus (102) of claim 2, further comprising a digital video decoder (406) capable of:
receiving a digital video signal containing the video content;
generating an analog video signal containing the video content; and
providing the analog video signal to the base layer encoder (204) and the enhancement layer encoder (206).

4. The apparatus (102) of claim 1, wherein the at least one of the one or more encoders (204, 206) and the one or more transcoders (502) comprises a digital video transcoder (502) capable of receiving a digital video signal containing the video content and generating a base layer and at least one enhancement layer.

5. The apparatus (102) of claim 1, further comprising a network interface (212) capable of communicating at least some of the multiple layers of the partitioned video content over a network (108);
wherein the data reader (210) is capable of providing at least some of the multiple layers of the partitioned video content for presentation by communicating at least some of the multiple layers of the partitioned video content to the network interface (212).

6. The apparatus (102) of claim 5, wherein:
the network interface (212) is capable of communicating at least some of the multiple layers of the partitioned video content to a video client (104) over the network (108); and
the video client (104) is capable of providing the video content for presentation on the display device (106).

7. The apparatus (102) of claim 6, wherein:
the at least one of the one or more encoders (204, 206) and the one or more transcoders (502) comprises at least one of:
a Motion Pictures Expert Group (“MPEG”) encoder;
a Fine Granularity Scalability (“FGS”) encoder;
a data partitioning encoder;
an MPEG-to-FGS transcoder; and
an MPEG-to-data partitioning transcoder;
the storage device (208) comprises a hard disk drive; and
the network (108) comprises a wireless Ethernet network.

8. The apparatus (102) of claim 1, further comprising:
a layer combiner (304) capable of combining at least some of the multiple layers of the partitioned video content into a video data stream; and
a digital video decoder (306) capable of decoding the video data stream and providing a video signal for presentation on the display device (126);
wherein the data reader (210) is capable of providing at least some of the multiple layers of the partitioned video content for presentation by communicating at least some of the multiple layers of the partitioned video content to the layer combiner (304).

9. The apparatus (102) of claim 1, wherein:
the multiple layers of the partitioned video content are retrieved from the storage device (208) in response to a request for the video content; and
the request for the video content is received from a video client (104) over a network (108), the video client (104) generating the request in response to a signal from a remote control (124) received at the video client (104).

10. The apparatus (102) of claim 1, wherein the apparatus (102) comprises a portion of a satellite television receiver, a cable set-top box, and a high-definition television receiver.

11. A method, comprising:
receiving video content from at least one source;
partitioning the video content into multiple layers;
storing the multiple layers of the partitioned video content in a storage device (208);
retrieving at least some of the multiple layers of the partitioned video content from the storage device (208) in response to a request for the video content; and
providing at least some of the multiple layers of the partitioned video content for presentation of the video content on a display device.

12. The method of claim 11, wherein partitioning the video content into multiple layers comprises:
generating a base layer; and
generating at least one enhancement layer.

13. The method of claim 12, wherein:
receiving the video content comprises receiving a digital video signal containing the video content;
the method further comprises generating an analog video signal containing the video content; and
generating the base layer and the at least one enhancement layer comprises generating the base layer and the at least one enhancement layer using the analog video signal.

14. The method of claim 11, wherein:
receiving the video content comprises receiving a digital video signal containing the video content; and
partitioning the video content into multiple layers comprises generating a base layer and at least one enhancement layer using the digital video signal.

15. The method of claim 11, wherein providing at least some of the multiple layers of the partitioned video content for presentation comprises communicating at least some of the multiple layers of the partitioned video content over a network (108) to a video client (104) capable of providing the video content for presentation on the display device (106).

16. The method of claim 11, wherein providing at least some of the multiple layers of the partitioned video content for presentation comprises:
combining at least some of the multiple layers of the partitioned video content into a video data stream;
decoding the video data stream to produce a video signal; and
providing the video signal for presentation on the display device (126).

17. The method of claim 11, wherein the request for the video content is received from a video client (104) over a network (108), the video client (104) generating the request in response to a signal from a remote control (124) received at the video client (104).

18. The method of claim 11, wherein the at least one source comprises at least one of: a satellite television receiver, a cable set-top box, a terrestrial antenna, a high definition television receiver, a personal computer, a video cassette recorder, and a digital versatile disk player.

19. A computer program embodied on a computer readable medium and operable to be executed by a processor, the computer program comprising computer readable program code for:
receiving video content from at least one source;
partitioning the video content into multiple layers;
storing the multiple layers of the partitioned video content in a storage device (208);
retrieving at least some of the multiple layers of the partitioned video content from the storage device (208); and
providing at least some of the multiple layers of the partitioned video content for presentation of the video content on a display device.

20. The computer program of claim 19, wherein the computer readable program code for partitioning the video content into multiple layers comprises computer readable program code for:
generating a base layer; and
generating at least one enhancement layer.

21. The computer program of claim 20, wherein:
the computer readable program code for receiving the video content comprises computer readable program code for receiving a digital video signal containing the video content;
the computer program further comprises computer readable program code for generating an analog video signal containing the video content; and
the computer readable program code for generating the base layer and the at least one enhancement layer comprises computer readable program code for generating the base layer and the at least one enhancement layer using the analog video signal.

22. The computer program of claim 19, wherein:
the computer readable program code for receiving the video content comprises computer readable program code for receiving a digital video signal containing the video content; and
the computer readable program code for partitioning the video content into multiple layers comprises computer readable program code for generating a base layer and at least one enhancement layer using the digital video signal.

23. The computer program of claim 19, wherein the computer readable program code for providing at least some of the multiple layers of the partitioned video content for presentation comprises computer readable program code for communicating at least some of the multiple layers of the partitioned video content over a network (108) to a video client (104) capable of providing the video content for presentation on the display device (106).

24. The computer program of claim 19, wherein the computer readable program code for providing at least some of the multiple layers of the partitioned video content for presentation comprises computer readable program code for:
combining at least some of the multiple layers of the partitioned video content into a video data stream;
decoding the video data stream to produce a video signal; and
providing the video signal for presentation on the display device (126).

25. The computer program of claim 19, wherein:
at least some of the multiple layers of the partitioned video content are retrieved in response to a request for the video content; and
the request for the video content is received from a video client (104) over a network (108), the video client (104) generating the request in response to a signal from a remote control (124) received at the video client (104).

26. A transmittable video signal produced by the steps of:
partitioning video content from at least one source into multiple layers;
storing the multiple layers of the partitioned video content in a storage device (208);
retrieving at least some of the multiple layers of the partitioned video content from the storage device (208) in response to a request for the video content; and
communicating at least some of the multiple layers of the partitioned video content for presentation of the video content on a display device.

27. A method, comprising:
receiving a request for video content that has been partitioned into multiple layers; and
retrieving at least some of the multiple layers of the partitioned video content from storage and providing at least some of the multiple layers of the partitioned video content for presentation without encoding the multiple layers.

28. An apparatus (102), comprising:
a storage device (208) capable of storing multiple layers of partitioned video content; and
a data reader (210) capable of retrieving at least some of the multiple layers of the partitioned video content from the storage device and providing at least some of the multiple layers of the partitioned video content for presentation of the video content on a display device without encoding the multiple layers.

29. A method, comprising:
receiving at least some of multiple layers of partitioned video content from a video server (102), the video server (102) capable of partitioning the video content into the multiple layers before storage of the multiple layers;
combining the received layers of the partitioned video content into a video data stream;
decoding the video data stream to produce a video signal; and
providing the video signal for presentation on a display device (106).

30. The method of claim 29, wherein receiving the multiple layers of the partitioned video content comprises receiving at least some of the multiple layers of the partitioned video content over a network (108).

31. The method of claim 29, further comprising communicating at least one control signal to the video server (102), the control signal based on input from a remote control (124).

32. An apparatus (104), comprising:
a layer combiner (304) capable of receiving at least some of multiple layers of partitioned video content from a video server (102) and combining the received layers of the partitioned video content into a video data stream, the video server (102) capable of partitioning the video content into the multiple layers before storage of the multiple layers; and
a digital video decoder (306) capable of decoding the video data stream and providing a video signal for presentation.

33. The apparatus (104) of claim 32, further comprising a network interface (302) capable of receiving at least some of the multiple layers of the partitioned video content from the video server (102) over a network (108).

34. The apparatus (104) of claim 32, further comprising a controller (308) capable of communicating at least one control signal to the video server (102), the control signal based on input from a remote control (124).

35. The apparatus (104) of claim 32, further comprising a display device (106) capable of presenting the video signal to at least one viewer.

36. A computer program embodied on a computer readable medium and operable to be executed by a processor, the computer program comprising computer readable program code for:
receiving at least some of multiple layers of partitioned video content from a video server (102), the video server (102) capable of partitioning the video content into the multiple layers before storage of the multiple layers;
combining the received layers of the partitioned video content into a video data stream;
decoding the video data stream to produce a video signal; and
providing the video signal for presentation on a display device (106).
